(19) United States
(12) Patent Application Publication
(10) Pub. No.: US 2008/0309854 A1
(43) Pub. Date: Dec. 18, 2008

(54) Wide Viewing Angle and Broadband Circular Polarizers for Transflective Liquid Crystal Displays

(76) Inventors: Zhibing Ge, Orlando, FL (US); Meizi Jiao, Orlando, FL (US); Ruibo Lu, Orlando, FL (US); Thomas Xinzhang Wu, Oviedo, FL (US); Shin-Tson Wu, Oviedo, FL (US); Wang-Yang Li, Xinhua Town (TW); Chung-Kuang Wei, Taipei City (TW)

Correspondence Address: BRIAN STEINBERGER/UCF, 101 BREVARD AVENUE, COCOA, FL, 32922, US

(21) Appl. No.: 11/763,839

(22) Filed: Jun. 15, 2007

(51) Int. Cl. G02F 1/1335

(52) U.S. Cl. 349/98

(57) ABSTRACT

Apparatus, devices, systems, and methods for wide viewing angle and broadband circular polarizers in transflective displays. A liquid crystal display configuration can include two stacked circular polarizers, each having a linear polarizer, a half-wave plate and a quarter-wave plate wherein two linear polarizers are crossed to each other, two half-wave plates are made of uniaxial A plates with opposite optical birefringence (one positive and one negative type), and two quarter-wave plates are made of uniaxial A plates with opposite optical birefringence (one positive and one negative type). The configurations can generate wide viewing angles and broadband properties and are suitable for display applications that require circular polarizers.

### FIELD OF THE INVENTION

The present invention is related to a transflective displays using circular polarizers, and more particularly to apparatus, devices, systems, and methods for wide viewing angle and broadband circular polarizers in transflective displays.

### BACKGROUND AND PRIOR ART

Transflective liquid crystal displays, generally rely on circular polarizers to module the light passing through it. Transflective liquid crystal displays are being widely used in various mobile devices due to its high image quality and good sunlight readability. Usually in a transflective LCD (liquid crystal display) device, each pixel is divided into a transmissive (T) region and a reflective (R) region. The R part requires a broadband circular polarizer to reach a good dark state, which requires the T part of LC cell to be sandwiched between two stacked of circular polarizers for a common dark state of the R mode. A broadband circular polarizer is generally required to cover the whole visible spectrum.

FIG. 1A shows a typical prior art broadband circular polarizer that can be found in many current transflective LCDs that consists of one linear polarizer along with one mono-chromatic half-wave plate and one mono-chromatic quarter-wave plate under a special alignment (S. Pancharatnam, “Achromatic combinations of birefringent plates: part I. An achromatic circular polarizer,” in Proc. Indian Academy of Science, vol. 41, sec. A, 1955, pp. 130-136), and both films are uniaxial positive A plates, that are made of stretched polymer films or homogeneous liquid crystal films. The extraordinary refractive index ne is aligned at the x-y plane, and is larger than their ordinary refractive index no (“Analytical solutions for uniaxial-film-compensated wide-view liquid crystal displays” by X. Zhu et al, Journal of Display Technology, vol. 2, pages 2-20, 2006).

One drawback of this prior art configuration is the poor viewing angle of the transmissive mode. The off-axis light leakage of such two stacked circular polarizers shown in FIG. 1B is further shown in FIG. 1C, in which the light leakages at different viewing angles (both azimuthal and polar directions) are correspondingly calculated. The calculated results are normalized to their maximum possible output value between two parallel aligned linear polarizers in the normal direction.

From FIG. 1C, the light leakage of two stacked broadband circular polarizers is severe at off-axis, e.g., the cone with light leakage <10% occurs within 40 degrees, which means the 10:1 contrast ratio of two stacked circular polarizers is limited to around 40 degrees. The poor viewing angle results from the accumulation of the off-axis phase retardation from both positive half-wave and quarter-wave A plates.

A proposal to overcome the narrow viewing angle for the two stacked circular polarizers is described by Lin et al in “Extraordinary wide-view and high-transmittance vertically aligned liquid crystal displays,” Applied Physics Letter, vol. 90, page 151112 (2007), as shown in FIG. 2a. Here, a liquid crystal layer such as a vertically aligned cell is sandwiched between two crossed circular polarizers, wherein each circular polarizer consists of a linear polarizer and a mono-chromatic quarter-wave plate, and a thin uniaxial A plate. The mono-chromatic quarter-wave plate has its optic axis set at 45° with respect to the absorption axis of its linear polarizer, and the thin uniaxial A plate has its optic axis perpendicular to the absorption axis of the neighboring linear polarizer. The top and bottom thin A plates are only used to compensate the off-axis light leakage of the two crossed linear polarizers, and are not working as half-wave plate, wherein the retardation of the A plates are much less than a half wavelength and the light passing through the each linear polarizer and its adjoining A plate will not change its polarization state at the normal incidence. By this configuration, the viewing angle can widely expanded to have contrast >10:1 over 80 degrees.

However, a drawback in this proposal is the narrow band performance for the reflective mode as shown in FIG. 2b, if this configuration of circular polarizer is employed to be a transflective LCD. The main reasons for this performance comes from the following factors: a). it uses a mono-chromatic quarter-wave plate and a linear polarizer in each circular polarizer, while the two A films between the polarizer and the quarter-wave plate at each side are only used to compensate the light off-axis light leakage of two linear polarizers, and are not working a half-wave plate to expand the bandwidth; and b). for the reflective mode, the light passing through the LC cell twice on the same top side, therefore it views the same typed quarter-wave plate (both positive as in FIG. 2b), therefore the quarter-wave plates the reflective light passes cannot compensate each other. FIG. 3a shows the wavelength dependent light leakage of the configuration in FIG. 2b.

From the analysis above, approaches to achieve a new circular polarizer structure for transflective displays with wider viewing angle and broadband properties is highly preferred. Thus, there exists the need for solutions to the problems described by the prior art.

### SUMMARY OF THE INVENTION

A primary objective of the invention is to provide apparatus, devices, systems, and methods for circular polarizers that can have wide viewing angles and are broadband for transflective liquid crystal displays.

A second objective of the invention is to provide new apparatus, devices, systems, and methods for a transmissive liquid crystal display device that can have wide viewing angles and broadband performance.

A preferred embodiment of the liquid crystal display device can include a first transparent substrate, a second transparent substrate, a liquid crystal cell having a liquid crystal layer sandwiched between the first and the second transparent substrates, a first circular polarizer disposed behind a viewer's side of the liquid crystal layer; wherein the first polarizer further includes a first linear polarizer, a first half-wave plate, a first quarter-wave plate, a second circular polarizer disposed on the viewer's side of the liquid crystal layer; wherein the second polarizer includes a second linear polarizer, a second half-wave plate, and a second quarter-wave plate, at least one optical retardation compensator disposed between the first circular polarizer and the second circular polarizer, wherein the first half-wave plate and the first quarter-wave plate are positioned between the inner surface of the first linear polarizer and the liquid crystal layer, having the first half-wave plate closer to the first polarizer than the first quarter-wave plate; and the second half-wave plate and the second quarter-wave plate are positioned between the inner surface of the second linear polarizer and the liquid crystal layer, having the second half-wave plate closer to the second polarizer than the second quarter-wave plate, wherein the first half-wave plate and the second half-wave plate are made of uniaxial A plates with opposite optical birefringence; and the first quarter-wave plate and the second quarter-wave plate are made of uniaxial A plates with opposite optical birefringence, a switch applied to the liquid crystal layer for switching the phase retardation of the liquid crystal layer between a zero and a half-wave plate value for attaining different gray levels.

The first linear polarizer and the second linear polarizer can include dichroic polymer films that have transmission axis perpendicular to each other. The dichroic polymer films can be a polyvinyl-alcohol-based film.

The first half-wave plate in the first circular polarizer that is away from the viewer can include a positive uniaxial A plate, the first quarter-wave plate includes a negative uniaxial A plate, the second half-wave plate includes a negative uniaxial A plate, and the second quarter-wave plate includes a positive uniaxial A plate. The positive and negative uniaxial A plates can have at least one of a polymer layer or a homogenous liquid crystal film.

The first half-wave plate in the first circular polarizer that is away from the viewer can include a negative uniaxial A plate, the first quarter-wave plate includes a positive uniaxial A plate; the second half-wave plate includes a positive uniaxial A plate and the second quarter-wave plate includes of negative uniaxial A plate. The positive and negative uniaxial A plates can have at least one of a polymer layer or a homogenous liquid crystal film.

The optic axis of the second half-wave plate can be set at an angle from −30° to −5° with respect to the transmission axis of the second linear polarizer, that is closer to the viewer; the second quarter-wave plate has its optic axis set at from approximately −15° to approximately +35° with respect to the transmission axis of the second linear polarizer, correspondingly; the first half-wave plate has its optic axis angle set at an angle from approximately −30° to approximately −5° with respect to the transmission axis of the second linear polarizer; and the first quarter-wave plate has its optic axis angle at an angle from approximately −15° to approximately +35° with respect to the transmission axis of the second linear polarizer, with respect to the transmission axis of the second linear polarizer.

The optic axis of the second half-wave plate can be set at an angle from approximately −30° to approximately −5° with respect to the transmission axis of the second linear polarizer, that is closer to the viewer; the second quarter-wave plate has its optic axis set at from approximately −15° to approximately +35° with respect to the transmission axis of the second linear polarizer, correspondingly; the first half-wave plate has its optic axis angle set at an angle from approximately −30° to approximately −5° with respect to the transmission axis of the second linear polarizer; and the first quarter-wave plate has its optic axis angle at an angle from approximately −15° to approximately +35° with respect to the transmission axis of the second linear polarizer, with respect to the transmission axis of the second linear polarizer.

The optic axis of the half-wave plate can be set at an angle from approximately +5° to approximately +30° with respect to the transmission axis of the second linear polarizer that is closer to the viewer, the second quarter-wave plate has its optic axis set at from approximately −35° to approximately +15° with respect to the transmission axis of the second linear polarizer, correspondingly, the first half-wave plate has its optic axis angle at an angle from approximately +5° to approximately +30° with respect to the transmission axis of the second linear polarizer, and the first quarter-wave plate has its optic axis angle set at an angle from approximately −35° to approximately +15° with respect to the transmission axis of the second linear polarizer, with respect to the transmission axis of the second linear polarizer.

The optic axis of the half-wave plate can be set at an angle from approximately +5° to approximately +30° with respect to the transmission axis of the second linear polarizer that is closer to the viewer, the second quarter-wave plate has its optic axis set at from approximately −35° to approximately +15° with respect to the transmission axis of the second linear polarizer, correspondingly, the first half-wave plate has its optic axis angle at an angle from approximately +5° to approximately +30° with respect to the transmission axis of the second linear polarizer, and the first quarter-wave plate has its optic axis angle set at an angle from approximately −35° to approximately +15° with respect to the transmission axis of the second linear polarizer, with respect to the transmission axis of the second linear polarizer.

The first half-wave plate can include a positive uniaxial A plate, the first quarter-wave plate includes a positive uniaxial A plate, the second half-wave plate includes a negative uniaxial A plate, and the second quarter-wave plate includes a negative uniaxial A plate. The positive and negative uniaxial A plates can have at least one of a polymer layer or a homogenous liquid crystal film.

The first half-wave plate can include a negative uniaxial A plate, the first quarter-wave plate includes a negative uniaxial A plate; the second half-wave plate includes a positive uniaxial A plate and the second quarter-wave plate includes a positive uniaxial A plate. The positive and negative uniaxial A plate can have at least one of a polymer layer or a homogenous liquid crystal film.

The optic axis of the second half-wave plate can be set at an angle from approximately −30° to approximately −5° with respect to the transmission axis of the second linear polarizer that is closer to the viewer, the second quarter-wave plate has its optic axis set at from approximately −15° to approximately +35° with respect to the transmission axis of the first linear polarizer that is away from the viewer correspondingly, the first half-wave plate has its optic axis angle set at an angle from approximately −30° to approximately −5° with respect to the transmission axis of the second linear polarizer, and the first quarter-wave plate has its optic axis angle at an angle from approximately −15° to approximately +35° with respect to the transmission axis of the first linear polarizer, with respect to the transmission axis of the second linear polarizer.

The optic axis of the second half-wave plate can be set at an angle from approximately −30° to approximately −5° with respect to the transmission axis of the second linear polarizer that is closer to the viewer, the second quarter-wave plate has its optic axis set at from approximately −15° to approximately +35° with respect to the transmission axis of the first linear polarizer that is away from the viewer correspondingly, the first half-wave plate has its optic axis angle set at an angle from approximately −30° to approximately −5° with respect to the transmission axis of the second linear polarizer, and the first quarter-wave plate has its optic axis angle at an angle from approximately −15° to approximately +35° with respect to the transmission axis of the first linear polarizer, with respect to the transmission axis of the second linear polarizer.

The optic axis of the second half-wave plate can be set at an angle from approximately +5° to approximately +30° with respect to the transmission axis of the second linear polarizer that is closer to the viewer, the second quarter-wave plate has its optic axis set at from approximately −35° to approximately +15° with respect to the transmission axis of the first linear polarizer that is away from the viewer correspondingly, the first half-wave plate has its optic axis angle set at an angle from approximately +5° to approximately +30° with respect to the transmission axis of the second linear polarizer, and the first quarter-wave plate has its optic axis angle set at an angle from approximately −35° to approximately +15° with respect to the transmission axis of the first linear polarizer, with respect to the transmission axis of the second linear polarizer.

The optic axis of the second half-wave plate can be set at an angle from approximately +5° to approximately +30° with respect to the transmission axis of the second linear polarizer that is closer to the viewer, the second quarter-wave plate has its optic axis set at from approximately −35° to approximately +15° with respect to the transmission axis of the first linear polarizer that is away from the viewer correspondingly, the first half-wave plate has its optic axis angle set at an angle from approximately +5° to approximately +30° with respect to the transmission axis of the second linear polarizer, and the first quarter-wave plate has its optic axis angle set at an angle from approximately −35° to approximately +15° with respect to the transmission axis of the first linear polarizer, with respect to the transmission axis of the second linear polarizer. The at least one optical retardation compensator can be laminated between the liquid crystal layer and one of the first and second circular polarizers.

The optical retardation compensator can include a negative C film having a total phase retardation value (dΔn) between approximately −400 nm to approximately −250 nm.

The liquid crystal cell can be a transmissive liquid crystal cell. The liquid crystal layer can be selected from a group consisting of: a vertically aligned cell, electrically controlled birefringence cell, and an optically compensated birefringence cell.

The liquid crystal cell can be a transflective liquid crystal display. The transflective display can include a first transparent substrate, a second transparent substrate, a liquid crystal cell, a first circular polarizer, wherein the first polarizer further includes a first linear polarizer, a first half-wave plate, a first quarter-wave plate, a second circular polarizer, wherein the second polarizer includes a second linear polarizer, a second half-wave plate, and a second quarter-wave plate; and the second circular polarizer located closer to the front side of the display than the first circular polarizer, and pixel circuits between the first and second substrates, each of the pixel circuits having a transmissive portion and a reflective portion, wherein the reflective portion includes a reflector for reflecting the external light, and the transmissive portion includes a transmitter to modulate light generated by an internal light source.

The transflective display can include a first transparent substrate, a second transparent substrate, a first circular polarizer, wherein the first polarizer further comprises of a first linear polarizer, a first half-wave plate, a first quarter-wave plate, a second circular polarizer, wherein the second polarizer comprises of a second linear polarizer, a second half-wave plate, and a second quarter-wave plate, the second circular polarizer can be located closer to the front side of the display than the first circular polarizer, and a liquid crystal layer, in which a portion of the liquid crystal layer is used to modulate light when the display is operating in a transmissive mode, and the same portion of the liquid crystal layer is used to modulate light when the display is operating in a reflective mode, and

The first half-wave plate and the first quarter-wave plate can be positioned between the inner surface of the first linear polarizer and the liquid crystal layer having the first half-wave plate closer to the first linear polarizer, and the second half-wave plate and the second quarter-wave plate are positioned between the inner surface of the second linear polarizer and the liquid crystal layer having the second half-wave plate closer to the second linear polarizer, and the first half-wave plate and the second half-wave plate are made of uniaxial A plates and are configured with opposite optical birefringence, and the first quarter-wave plate and the second quarter-wave plate are made of uniaxial A plates and are configured with opposite optical birefringence.

The first half-wave plate and the first quarter-wave plate can be positioned between the inner surface of the first linear polarizer and the liquid crystal layer having the first half-wave plate closer to the first linear polarizer, and the second half-wave plate and the second quarter-wave plate are positioned between the inner surface of the second linear polarizer and the liquid crystal layer having the second half-wave plate closer to the second linear polarizer, and the first half-wave plate and the second half-wave plate are made of uniaxial A plates and are configured with opposite optical birefringence, and the first quarter-wave plate and the second quarter-wave plate are made of uniaxial A plates and are configured with opposite optical birefringence.

Further objects and advantages of this invention will be apparent from the following detailed description of preferred embodiments which are illustrated schematically in the accompanying drawings.

### BRIEF DESCRIPTION OF THE FIGURES

FIG. 1A is the structure of a conventional prior art broadband circular polarizer.

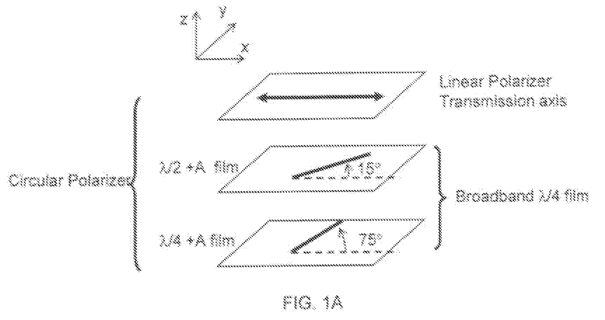

FIG. 1B is a diagram of two stacked conventional circular polarizers of FIG. 1A.

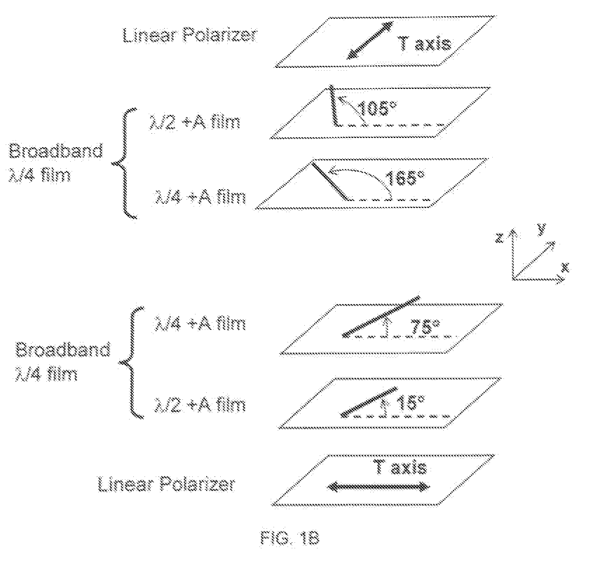

FIG. 1C is the angular dependent light leakage of two stacked conventional circular polarizers.

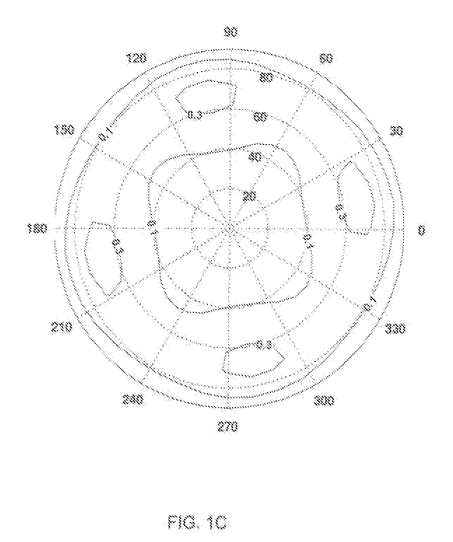

FIG. 2A is a prior art view of wide viewing circular polarizers for transmissive mode.

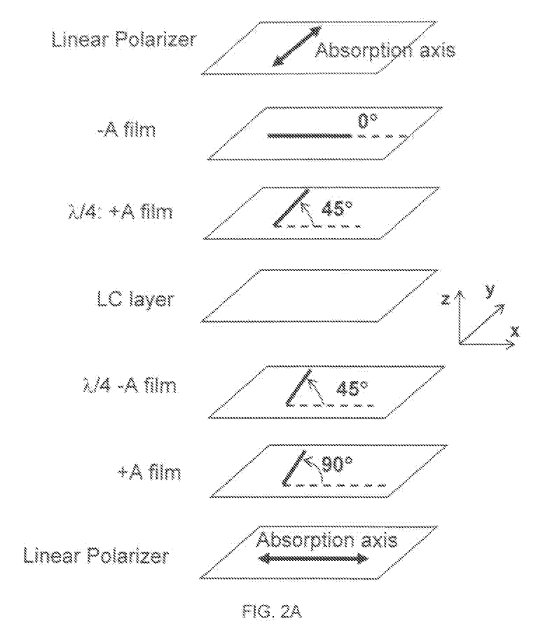

FIG. 2B shows the configuration of a reflective display device using the circular polarizer in FIG. 2A.

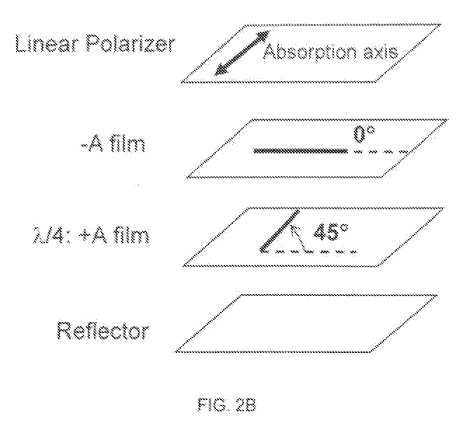

FIG. 2C shows the wavelength dependent light leakage for a reflective device using the circular polarizer in FIG. 2A.

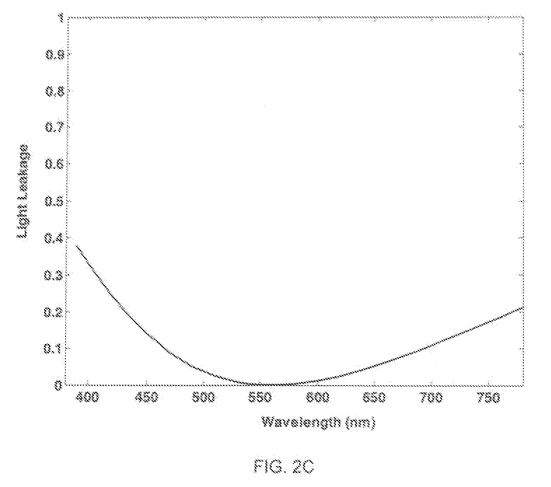

FIG. 3A shows the structure of the first embodiment of the invention.

FIG. 3B is the optic axis alignment for each layer in the first embodiment of FIG. 3A.

FIG. 4A is polarization trace on the Poincaré sphere for each broadband circular polarizer.

FIG. 4B shows a mechanism for dark state on the Poincaré sphere.

FIG. 4C shows a mechanism for bright state on the Poincaré sphere.

FIG. 5A shows the wavelength dependent transmissive light leakage of the first embodiment with

$${ϕ}_{+ \frac{1}{2} λ} = approximately 75 ° and {ϕ}_{- \frac{1}{4} λ} = approximately - 75 ° , and$$

$${ϕ}_{- \frac{1}{2} λ} = approximately 75 ° and {ϕ}_{+ \frac{1}{4} λ} = approximately - 75 ° .$$

FIG. 5B shows the wavelength dependent reflective light leakage of the first embodiment with

$${ϕ}_{- \frac{1}{2} λ} = approximately 75 ° and {ϕ}_{+ \frac{1}{4} λ} = approximately - 75 ° .$$

FIG. 6 shows the wavelength dependent transmissive light leakage of the first embodiment with

$${ϕ}_{+ \frac{1}{2} λ} = approximately 73 ° and {ϕ}_{+ \frac{1}{4} λ} = approximately - 79 ° , and$$

$${ϕ}_{- \frac{1}{2} λ} = approximately 77 ° and {ϕ}_{+ \frac{1}{4} λ} = approximately - 71 ° .$$

FIG. 7A shows the angular dependent light leakage of two stacked broadband circular polarizers with

$${ϕ}_{+ \frac{1}{2} λ} = approximately 75 ° and {ϕ}_{- \frac{1}{4} λ} = approximately - 75 ° , and$$

$${ϕ}_{- \frac{1}{2} λ} = approximately 75 ° and {ϕ}_{+ \frac{1}{4} λ} = approximately - 75 ° .$$

FIG. 7B shows the angular dependent light leakage of two stacked broadband circular polarizers with

$${ϕ}_{+ \frac{1}{2} λ} = approximately 73 ° and {ϕ}_{- \frac{1}{4} λ} = approximately - 79 ° , and$$

$${ϕ}_{- \frac{1}{2} λ} = approximately 77 ° and {ϕ}_{- \frac{1}{4} λ} = approximately - 71 ° .$$

FIG. 8 shows the iso-contrast plot for the configuration in the first embodiment.

FIG. 9A shows the structure of a second embodiment of the invention.

FIG. 9B shows the optic axis alignment for each layer in the second embodiment of FIG. 9B.

FIG. 10 shows the off-axis light leakage of two stacked broadband circular polarizer of the second embodiment.

FIG. 11 shows the iso-contrast plot for the configuration in the second embodiment.

FIG. 12A shows the structure of the third embodiment of the invention.

FIG. 12B shows the optic axis alignment for each layer in the third embodiment.

FIG. 13A shows a polarization trace on the Poincaré sphere for each broadband circular polarizer.

FIG. 13B shows a mechanism for dark state on the Poincaré sphere.

FIG. 13C shows a mechanism for bright state on the Poincaré sphere.

FIG. 14A shows the wavelength dependent transmissive light leakage of the third embodiment with

$${ϕ}_{+ \frac{1}{2} λ} = approximately 75 ° , {ϕ}_{+ \frac{1}{4} λ} = approximately 15° , \\ {ϕ}_{- \frac{1}{2} λ} = approximately 75 ° and {ϕ}_{- \frac{1}{4} λ} = approximately 15° .$$

FIG. 14B shows the wavelength dependent reflective light leakage of the third embodiment with

$${ϕ}_{+ \frac{1}{2} λ} = approximately 75 ° , {ϕ}_{+ \frac{1}{4} λ} = approximately 15° , \\ {ϕ}_{- \frac{1}{2} λ} = approximately 75 ° and {ϕ}_{- \frac{1}{4} λ} = approximately 15° .$$

FIG. 15 shows the wavelength dependent transmissive light leakage of the third embodiment with

$${ϕ}_{+ \frac{1}{2} λ} = approximately 78 ° , {ϕ}_{+ \frac{1}{4} λ} = approximately 21 ° , {ϕ}_{- \frac{1}{4} λ} = approximately 13 ° and {ϕ}_{- \frac{1}{2} λ} = approximately 74 ° .$$

FIG. 16A shows the off-axis light leakage of two stacked broadband circular polarizer of the third embodiment with

$${ϕ}_{+ \frac{1}{2} λ} = approximately 75 ° , {ϕ}_{+ {1}_{4} λ} = approximately 15 ° , {ϕ}_{- {1}_{2} λ} = approximately 75 ° and {ϕ}_{- \frac{1}{4} λ} = approximately 15 ° .$$

FIG. 16B shows the off-axis light leakage of two stacked broadband circular polarizer of the third embodiment with

$${ϕ}_{+ {1}_{2} λ} = approximately 78 ° , {ϕ}_{+ {1}_{4} λ} = approximately 21 ° , {ϕ}_{- \frac{1}{4} λ} = approximately 13 ° and {ϕ}_{- {1}_{2} λ} = approximately 74 ° .$$

FIG. 17 shows the iso-contrast plot for the configuration in the fourth embodiment of the invention.

FIG. 18A shows the structure of a fourth embodiment of the invention.

FIG. 18B shows the optic axis alignment for each layer in the fourth embodiment.

FIG. 19 shows the off-axis light leakage of two stacked broadband circular polarizer of the fourth embodiment.

FIG. 20 shows the iso-contrast plot for the configuration in the fourth embodiment.

### DESCRIPTION OF THE PREFERRED EMBODIMENTS

Before explaining the disclosed embodiments of the present invention in detail it is to be understood that the invention is not limited in its application to the details of the particular arrangements shown since the invention is capable of other embodiments. Also, the terminology used herein is for the purpose of description and not of limitation.

### Embodiment 1

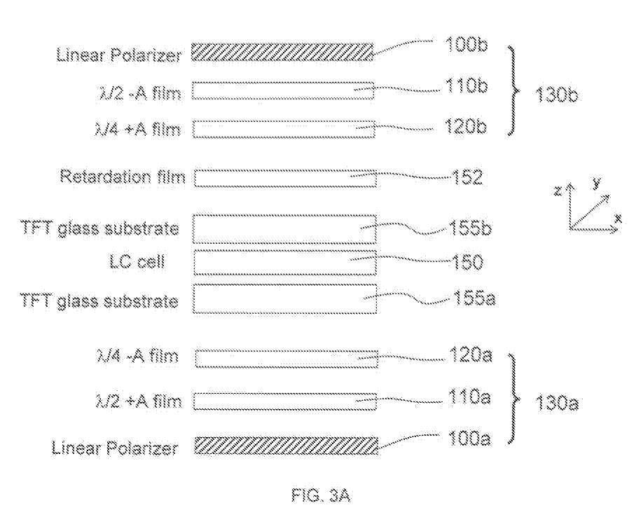

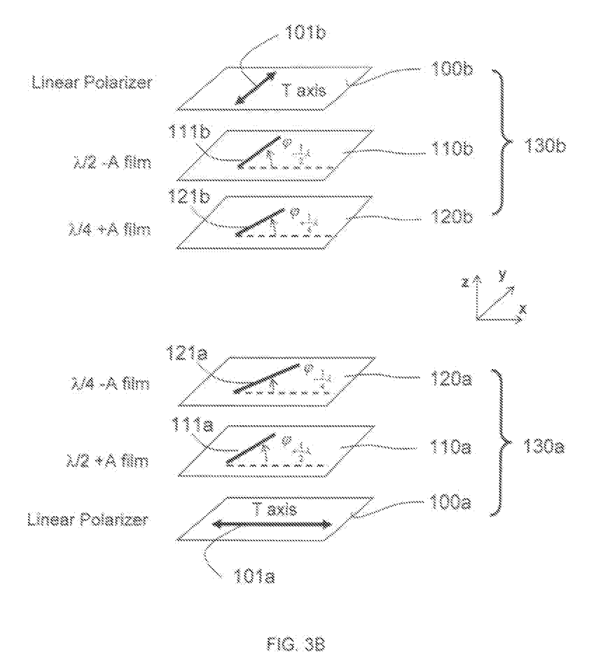

FIG. 3A is cross-sectional diagram of a first embodiment of the wide-view and broadband circular polarizer configuration in a transflective typed LCD or for the pure T typed LCD. A liquid crystal layer 150, such as a vertically aligned LC cell, is sandwiched between a first glass substrate 155a and a second glass substrate 155b, wherein a thin-film-transistor (TFT) array such as those shown and described in U.S. Pat. Nos. 5,528,055 to Komori; 6,424,396 to Kim et al.; and 6,760,087, each of which are incorporated by reference. A TFT transistor array can be formed on the bottom substrate 155a to provide driving voltages to modulate the liquid crystal layer therebetween.

The liquid crystal layer along with the two glass substrates are further interposed between two stacked broadband circular polarizers 130a and 130b, wherein these two circular polarizers compensate with each other to reduce the off-axis light leakage. The first circular polarizer 130a consists of a first linear polarizer 100a, a first half-wave plate 110a, and a first quarter-wave plate 120a, wherein the half-wave plate 110a is laminated between the polarizer 100a and the quarter-wave plate 120a. The first half-wave plate 110a is made of a positive uniaxial A plate (e.g., stretched polymer film or homogeneous liquid crystal film), wherein its extraordinary refractive index ne is aligned at the x-y plane and is larger than its ordinary refractive index no. The first quarter-wave plate 120a is made of a negative uniaxial A plate, with its extraordinary refractive index ne aligned at the x-y plane and is smaller than its ordinary refractive index no.

On the other side of the liquid crystal layer 150, a second linear polarizer 1001, a second half-wave plate 110b made of negative uniaxial A plate, and a second quarter-wave plate 120b made of positive uniaxial A plate form the second circular polarizer 130b. At least one retardation film 152 such as a negative C plate is laminated between the liquid crystal layer 150 and the top and bottom circular polarizers, respectively.

The alignment of optic axis for each layer is illustrated in FIG. 3B, wherein the transmission axis 101a of the linear polarizer 100a is set as the x-axis. The first half-wave plate 110a has its optic axis 111a set at an angle

$${ϕ}_{+ {1}_{2} λ}$$

with respect to the transmission axis 101a of the linear polarizer 100a. The quarter-wave plate 120a has its optic axis 121a set at an angle

$${ϕ}_{- \frac{1}{4} λ}$$

with respect to the transmission axis 101a of the linear polarizer 100a. The transmission axis 101b of the second linear polarizer 100b is perpendicular to the transmission axis 101a of the first linear polarizer. The optic axis 111b of the half-wave plate 110b is set at an angle

$${ϕ}_{- \frac{1}{2} λ}$$

with respect to the transmission axis 101a of the first linear polarizer 100a. And the optic axis of 121b the quarter-wave plate 120b has an angle

$${ϕ}_{+ \frac{1}{4} λ}$$

with respect to the transmission axis 101a of the first linear polarizer 100a.

Because the wave plates are all made of uniaxial A plates wherein their extraordinary axes are all aligned in the x-y plane, an alignment with optic axis angle at φ is equivalent to the one with optic axis aligned at φ±π in the same x-y plane, e.g., one A film with φ=approximately 80° is same as the A film with its azimuthal angle with φ=approximately −100°. As a result, to uniquely define an alignment direction of one A plate, the angle can be defined in the range of (−π/2 , π/2] to represent all the possible alignment values.

To work as a wide-view and broadband circular polarizers for a transflective LCD, the alignment angles of these A films need to satisfy, certain relations. Generally, three requirements need to be satisfied:

1.) the angle of the top half-wave plate that is closer to the viewer needs to be around approximately ±15° away from the transmission axis of the top linear polarizer, as to make the reflective mode a broadband mode;

2.) in each circular polarizer, the azimuthal angles of the half-wave plate and quarter-wave plate needs to satisfy certain relations to make each a broadband circular polarizer; and

3.) the corresponding half-wave plates (or quarter-wave plates) needs to be aligned closely parallel to each other, to compensate the off-axis light leakage. Detailed explanations will be illustrated in the examples followed.

For the structure in FIG. 3B to work as a broadband circular polarizer, the alignment angle of each uniaxial A plate in each circular polarizer (130a and 130b) needs to satisfy special relations. First, the angle

$${ϕ}_{- \frac{1}{2} λ}$$

of the top half-wave plate is set at approximately 75° with respect to the transmission axis of the bottom circular polarizer, which is also approximately −15° away from the top polarizer's transmission direction 101b. Therefore, the bottom half-wave plate also needs to set its angle

$${ϕ}_{+ \frac{1}{2} λ}$$

at approximately 75° from abovementioned requirements.

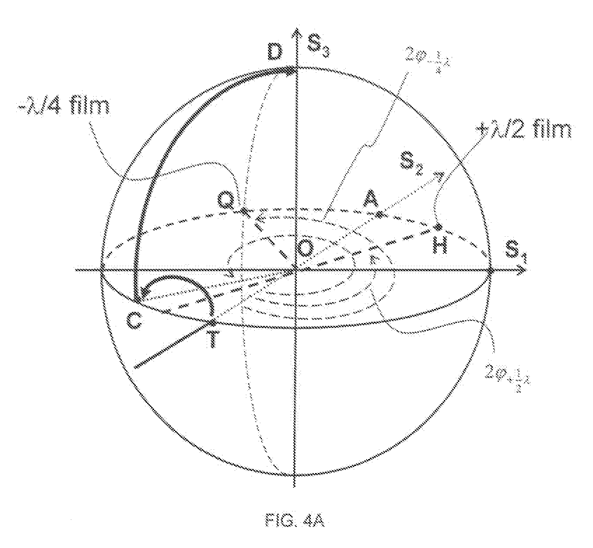

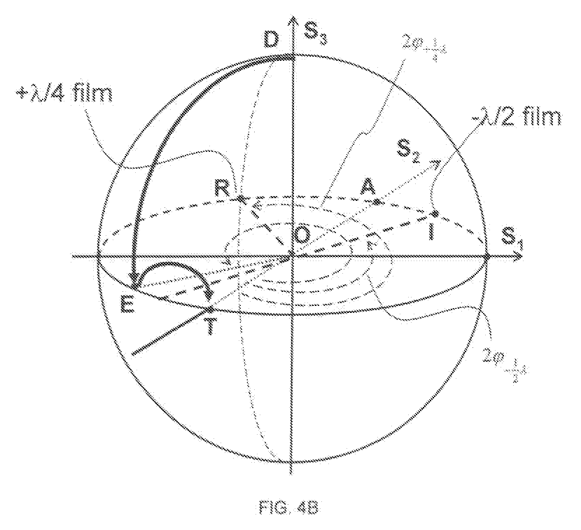

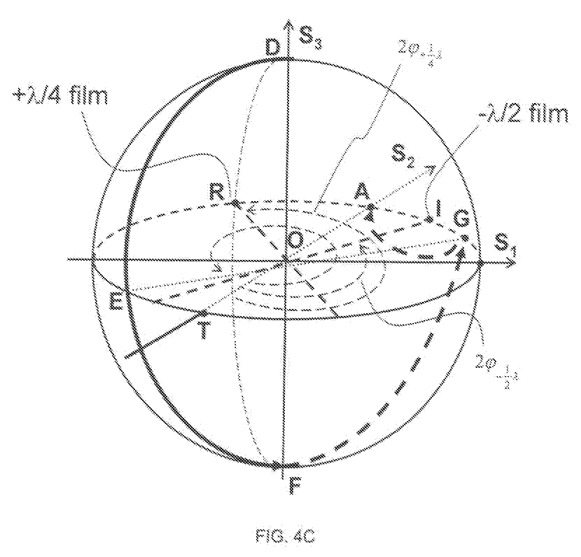

FIG. 4A shows the change of the polarization states traced on a Poincaré sphere (where the equator represents linear polarizations, and the poles stand for circular polarizations with different handiness) for a light passing through these two stacked circular polarizers at a normal incidence. Point T depicts the transmission axis 101a of the polarizer 100a on the Poincaré sphere, which also represents the polarization state of the incident light passing through the bottom linear polarizer 100a. As the top and bottom polarizers are crossed to each other, the transmission axis of the top polarizer is represented by the point A on the Poincaré sphere, where ∠AOT=2×90°=approximately 180°.

Because the optic axis of the first half-wave plate 110a is at

$${ϕ}_{+ \frac{1}{2} λ}$$

to the transmission axis 101a in FIG. 3B, the point H representing its optic axis 111a of the half-wave plate 110a on the Poincaré sphere has an angle of

$$2 {ϕ}_{+ \frac{1}{2} λ}$$

with respect to the axis OT, i.e.,

$$∠ HOT = 2 {ϕ}_{+ \frac{1}{2} λ} = 2 \times 75 ° = approximately 150 ° .$$

Similarly the point Q representing optic axis 121a of the quarter-wave plate 120a on the Poincaré sphere has an angle of

$$2 {ϕ}_{- \frac{1}{4} λ}$$

with respect to the axis OT, i.e.,

$$∠ QOT = 2 {ϕ}_{+ \frac{1}{4} λ} .$$

Under such a configuration, the light passing through the linear polarizer 100a will first have a polarization state at point T (linear polarization); then it will be rotated half a circle on the Poincaré sphere surface (equal to λ/2 change on the Poincaré sphere) along the axis OH to the point C by the half-wave plate 110a, where the light still keeps a linear polarization state and the angle

$$∠ COT = 4 {ϕ}_{+ \frac{1}{2} λ} = approximately 300 ° .$$

In order to transfer the light to a circular polarization (to move polarization state from point C to point D), the axis OQ for the quarter-wave plate needs to be perpendicular to the OC axis, i.e, ∠QOT=approximately ±90°, or the following relation

$$2 {ϕ}_{- \frac{1}{4} λ} - 4 {ϕ}_{+ \frac{1}{2} λ} = \pm \frac{π}{2}$$

needs to be satisfied.

In order to make this single circular polarizer broadband, the trace of polarization change should be kept in the same top or bottom half sphere. Therefore, for the case with a positive A plate for half-wave plate and a negative A plate for the quarter-wave plate with

$${ϕ}_{+ \frac{1}{2} λ} = approximately 75 ° ,$$

the relation should be

$$2 {ϕ}_{- \frac{1}{4} λ} - 4 {ϕ}_{+ \frac{1}{2} λ} = - \frac{π}{2} , i . e . , {ϕ}_{- \frac{1}{4} λ} = approximately - 75 ° .$$

Similarly, the optic angles of the top half-wave plate 120b and the top quarter-wave plate 110b needs to satisfy

$$2 {ϕ}_{- \frac{1}{4} λ} - 4 {ϕ}_{- \frac{1}{2} λ} = - \frac{π}{2} , where {ϕ}_{- \frac{1}{2} λ} = approximately 75 ° .$$

More generally, the angle between their optic axes should be

$$2 {ϕ}_{\frac{1}{2} λ} - 4 {ϕ}_{\frac{1}{2} λ} = - \frac{π}{2} + 2 m π ,$$

here m is an integer that can be 0 or ±1, and each φ is in the range of (−π/2 , π/2], here m is equal to −1.

FIG. 4B shows the dark state mechanism from the Poincaré sphere for the transmissive part. The optic axis of the half-wave plate 110b can be represented by the point I with

$$∠ IOT = 2 {ϕ}_{- \frac{1}{2} λ} = approximately 150 ° ,$$

and the optic axis of the quarter-wave plate 120b can be represented by the point R with

$$∠ ROT = 2 {ϕ}_{+ \frac{1}{4} λ} = approximately - 150 °$$

or approximately 210°. Under such a configuration, the light passing through the bottom circular polarizer 130a will have a first circular polarization state as point D in FIG. 4A. If the LC layer 150 introduces no phase retardation for the light at normal direction, it will keep its polarization after the LC layer. Because the optic axis of the half-wave plate and the top quarter-wave plate satisfying

$$2 {ϕ}_{+ \frac{1}{4} λ} - 4 {ϕ}_{\frac{1}{2} λ} = - \frac{π}{2} + 2 m π ,$$

as shown in FIG. 4B, the circularly polarized light will move from point D to E by the quarter-wave plate 120b and then from E to T by the half-wave plate 110b.

Because the absorption axis 101b of the top linear polarizer 100b is parallel to the transmission axis 101a of the bottom polarizer 100a, the light will be blocked and absorbed by the top linear polarizer 100b. Thus a dark state can be achieved. For the reflective mode, similar analysis can be applied and a common dark state can be obtained as the transmissive mode.

On the other hand, if the liquid crystal layer is driven by certain voltage from the TFT arrays on the glass substrate to behave like a have-wave plate, a bright state can be achieved. Under this case, the light passing the bottom circular polarizer will be a circularly polarized light, which is represented by the point D on the north pole of the Poincaré sphere. The liquid crystal will change its handiness from the north pole D to the south pole F by its half-wavelength like phase retardation. Then the quarter-wave plate 120b will move the light from point F to point G, which is a point opposite to the point E through axis EO. Finally the half-wave plate 110b moves the light from point G to point A, where the point A is the transmission axis position of the top polarizer 100b. As a result, a bright state can be achieved.

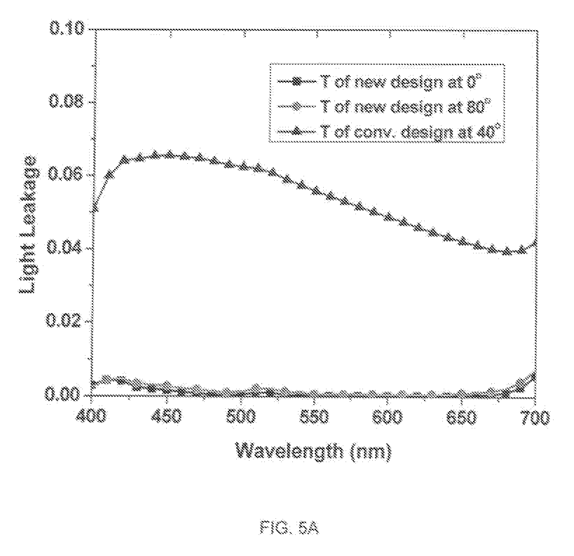

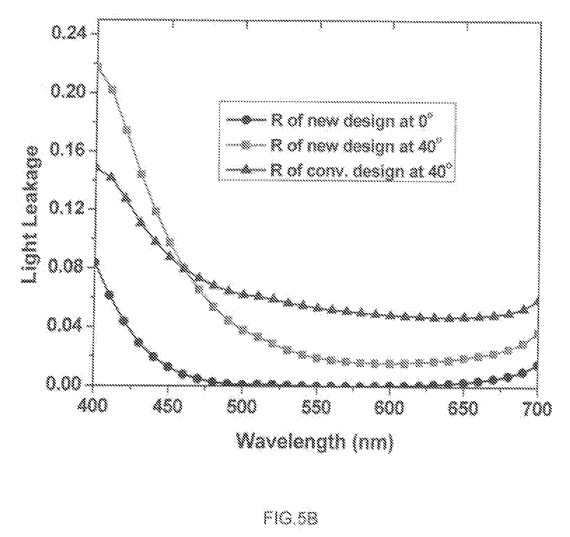

FIG. 5A shows the transmissive light leakage at the dark state of the abovementioned configurations in FIG. 3B in the visible spectrum from λ/approximately 380 nm to λ=approximately 780 nm. The extraordinary and ordinary refractive index ne and no of the positive A plates are set as no=approximately 1.5866 and ne=approximately 1.5902, and those for the negative A plates are set as no=approximately 1.60 and ne=approximately 1.50 at λ=approximately 589 nm. And the centered wavelength is set at approximately 550 nm. Their optic axis alignments are as the followings:

$${ϕ}_{+ \frac{1}{2} λ} = 75 ° , {ϕ}_{- \frac{1}{4} λ} = - 75 ° , {ϕ}_{- \frac{1}{2} λ} = 75 ° and {ϕ}_{+ \frac{1}{4} λ} = - 75 ° .$$

It can be seen from the figure that this polarizer is quite broadband with light leakage less than approximately 0.5% in the whole visible spectrum. FIG. 5B shows the reflective light leakage at the dark state using only top circular polarizer 130b and a reflector. As we can see, the transmittance still keeps a broadband property with leakage less than approximately 0.5% from approximately 450 nm to approximately 700 nm, and the reflectance is less than approximately 2% in the same spectrum, which makes it suitable for both T and R modes in a transflective LCD.

Besides, the configuration here also shows a wide-view property, as shown in FIG. 5A, where the wavelength dependent light leakage for the transmissive mode at an incident polar angle of approximately 80° is almost same to that in the normal direction, while the conventional even produces a large leakage at angle of approximately 40°. The off-axis wavelength dependent light leakage of the reflective mode of this example is also better than that of the conventional one, as indicated in FIG. 5B.

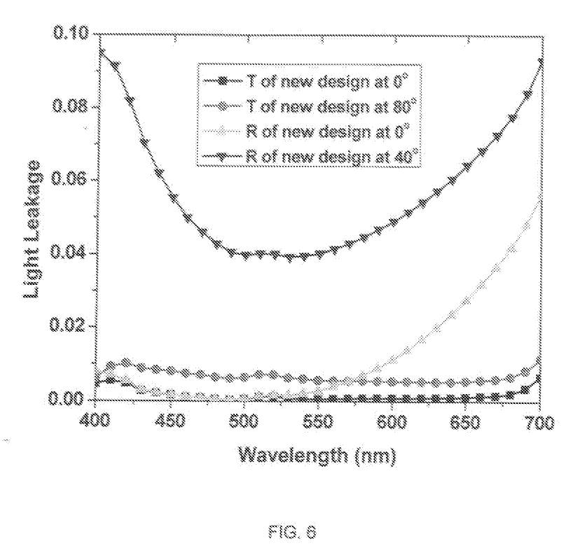

The optic axis angles of the bottom and top complementary retardation plates are not necessarily equal and set exactly at approximately 75°. FIG. 6 shows the wavelength dependent light leakage with

$${ϕ}_{- \frac{1}{2} λ} = approximately 73 ° and {ϕ}_{- \frac{1}{4} λ} = approximately - 79 ° , and {ϕ}_{- \frac{1}{2} λ} = approximately 77 ° and {ϕ}_{+ \frac{1}{4} λ} = approximately - 71 ° .$$

Throughout the whole approximately 450 nm to approximately 700 nm spectrum, the light leakage is less than approximately 0.1% for T mode, and approximately 6% for the R mode. Here in FIG. 6, the phase retardation of the liquid crystal layer and the C film is also included.

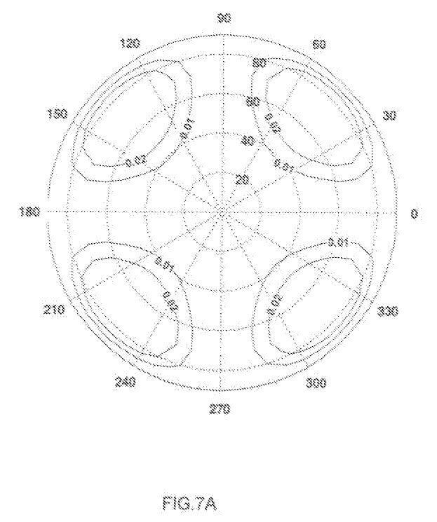

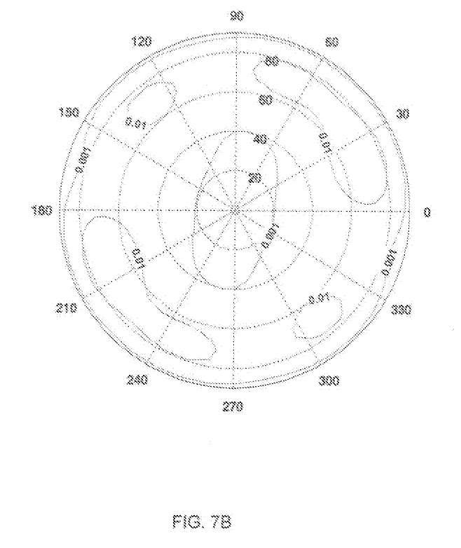

With complementary optical refractive index between the two half-wave plates and the two quarter-wave plates, respectively, the off-axis light leakage can be greatly suppressed. FIG. 7A shows the light leakage of the configurations, where

$${ϕ}_{+ \frac{1}{2} λ} = approximately 75 ° , {ϕ}_{- \frac{1}{4}} = approximately - 75 ° , {ϕ}_{- \frac{1}{2} λ} = approximately 75 ° , and {ϕ}_{+ \frac{1}{4} λ} = approximately - 75 ° .$$

It shows expand the light leakage >approximately 1% over approximately 40°, which is much better than the configurations using all positive A plates.

Considering a liquid crystal layer having its molecules substantially perpendicular to the substrate at its dark state, such as a normally black mode VA cell sandwiched between above-configured circular polarizers, additional negative C film 152 (where their extraordinary refractive index ne aligned at the z axis and its ne is smaller than the ordinary refractive index no) can be added to the two sides of the VA cell to mainly compensate the off-axis phase retardation from the LC part, as shown in FIG. 3A.

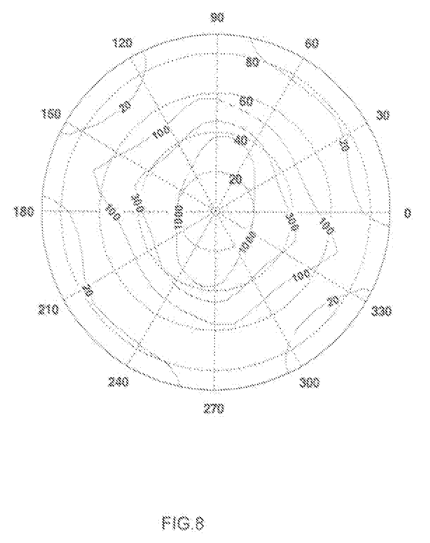

The calculated iso-contrast plot of the current example is shown in FIG. 8. In the calculation, the LC cell is set at approximately 4 μm, using a negative dielectric anisotropic liquid crystal material MLC-6608, available from Merck, Germany that has a parallel dielectric constant ∈_{∥}=approximately 3.6, a perpendicular dielectric constant ∈_{⊥}=approximately 7.8, elastic constants K₁₁=approximately 16.7 pN, K₃₃=approximately 18.1 pN, an extraordinary refractive index ne=approximately 1.5578, and an ordinary refractive index no=approximately 1.4748 at wavelength λ=approximately 589 nm. The negative C films are have their extraordinary refractive index ne=approximately 1.49288 and ordinary refractive index no=approximately 1.50281.

The phase retardation value dΔn of the C film is set at approximately −360 nm. The optic axis angles of the half-wave and quarter-wave plate are

$${ϕ}_{+ \frac{1}{2} λ} = approximately 73 ° and {ϕ}_{- \frac{1}{4} λ} = approximately - 79 ° , and {ϕ}_{- \frac{1}{2} λ} = approximately 77 ° and {ϕ}_{+ \frac{1}{4} λ} = approximately - 71 ° .$$

FIG. 7B shows the angular light leakage of the above alignment angles and retardation films, the off-axis light leakage is greatly suppressed to less than approximately 0.015, which is improved from that in FIG. 7A. The iso-contrast ratio plot is shown in FIG. 8, where the contrast ratio approximately 10 to 1 is expanded to over entire viewing cone, which is much greatly improved as compared to the case using all positive A plates.

On the other hand, the azimuthal angle of the top half-wave plate can also be aligned at approximately −75° with respect to the transmission axis 101a of the bottom linear polarizer, which is also approximately +15° to the transmission axis 101b. Therefore a broad bandwidth for the reflective mode can also be guaranteed. In this case, with the assistance of Poincaré sphere, the angles of the half-wave plate and quarter-wave need to satisfy

$$2 {ϕ}_{\frac{1}{4} λ} - 4 {ϕ}_{\frac{1}{2} λ} = + \frac{π}{2} + 2 m π ,$$

where m is an integer that can be 0 or ±1. For example

$${ϕ}_{+ \frac{1}{2} λ} = approximately - 75 ° , {ϕ}_{- \frac{1}{4} λ} = approximately 75 ° , {ϕ}_{- \frac{1}{2} λ} = approximately - 75 ° and {ϕ}_{+ \frac{1}{4} λ} = approximately 75 ° ,$$

where m=approximately +1.

Here the LCD device can also be a pure transmissive typed LCD. And the liquid crystal layer is not confined to a normally black initially vertically aligned cell, it can also use a normally white ECB cell (electrically controlled birefringence) or an OCB cell (optically compensated birefringence) where the LC molecules are substantially vertically aligned at high voltages that are much larger than the threshold voltage of the material. Besides, additional compensation films for the LC cell not illustrated here can be added without departing from the spirit of the present invention, and should not be considered as a limitation of this invention.

### Embodiment 2

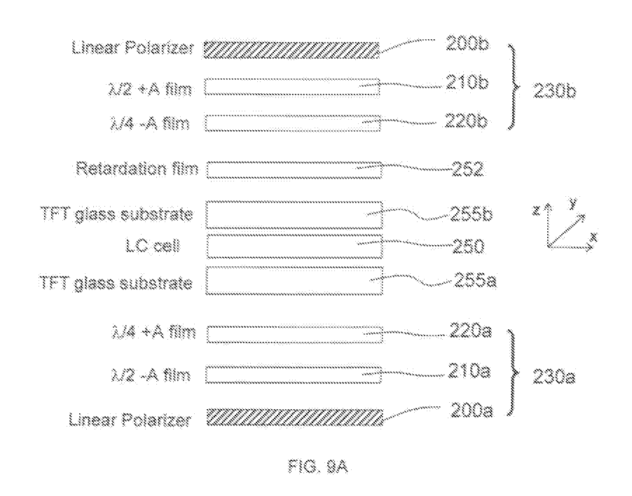

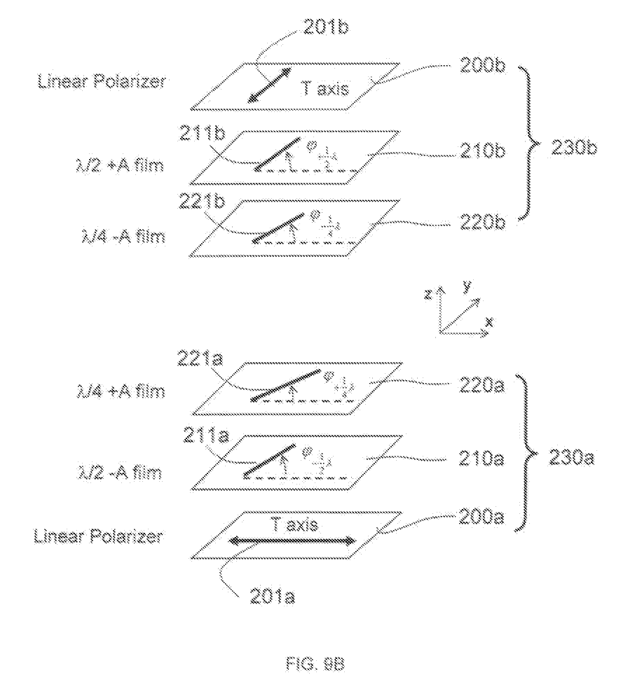

In a second embodiment of the present invention as shown in FIG. 9A, the birefringence of each A plate is just set opposite in correspondence to the configuration in FIG. 3A, wherein the LC cell 250 is sandwiched between a first glass substrate 255a and a second glass substrate 255b, wherein a thin-film-transistor (TFT) array (not shown here) is formed on the bottom substrate 255a to provide driving voltages to modulate the liquid crystal layer therebetween. The liquid crystal layer along with the two glass substrates are further interposed between two circular polarizers 230a and 230b. The first circular polarizer 230a further comprises of a first linear polarizer 200a, a first half-wave plate 210a, and a first quarter-wave plate 220a. The second circular polarizer 230b further comprises of a second linear polarizer 200b, a second half-wave plate 210b, and a second quarter-wave plate 220b. Their optic axis is shown in FIG. 9B.

As described in abovementioned Embodiment 1, when the birefringence of the half-wave and quarter-wave A plate within each circular polarizer is opposite (e.g. a positive A plate for one wave plate and a negative A plate the other one), the angle between their optic axes should be

$$2 {ϕ}_{\frac{1}{4} λ} - 4 {ϕ}_{\frac{1}{2} λ} = \pm \frac{π}{2} + 2 m π ,$$

here m is an integer that can be 0 or ±1, and each φ is in the range of (−π/2, π/2]. Here if

$${ϕ}_{{1}_{2} λ} = approximately 75 ° , then 2 {ϕ}_{\frac{1}{4} λ} - 4 {ϕ}_{\frac{1}{2} λ} = - \frac{π}{2} + 2 m π$$

should be satisfied, e.g.,

$${ϕ}_{- \frac{1}{2} λ} = approximately + 75 ° , {ϕ}_{+ \frac{1}{4} λ} = approximately - 75 ° , {ϕ}_{- \frac{1}{4} λ} = approximately - 75 ° , {ϕ}_{+ \frac{1}{2} λ} = approximately + 75 ° , and m = - 1.$$

And on the other hand, if

$${ϕ}_{{1}_{2} λ} = approximately - 75 ° , then 2 {ϕ}_{\frac{1}{4} λ} - 4 {ϕ}_{\frac{1}{2} λ} = + \frac{π}{2} + 2 m π$$

should be satisfied, e.g.,

$${ϕ}_{- {1}_{2} λ} = approximately - 75 ° , {ϕ}_{+ {1}_{4} λ} = approximately + 75 ° , {ϕ}_{- \frac{1}{4} λ} = approximately + 75 ° , {ϕ}_{+ {1}_{2} λ} = approximately - 75 ° , and m = + 1.$$

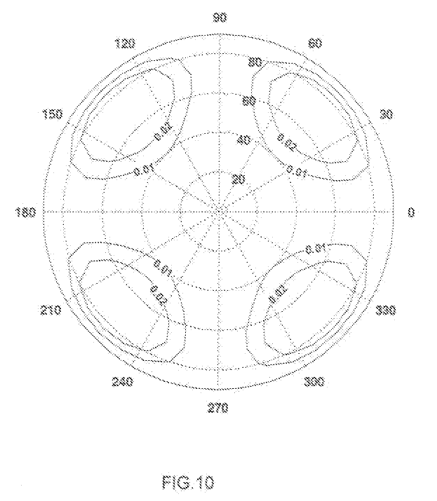

FIG. 10 shows the light leakage where

$${ϕ}_{- {1}_{2} λ} = approximately + 75 ° and {ϕ}_{+ \frac{1}{4} λ} = approximately - 75 °$$

in the bottom polarizer,

$${ϕ}_{+ \frac{1}{2} λ} = approximately + 75 ° and {ϕ}_{- \frac{1}{4} λ} = approximately - 75 °$$

in the top circular polarizer. In this case the reflective ambient light will first see a positive half-wave plate then a negative quarter-wave plate, as different from the example in the first embodiment. Similarly the light leakage at off-axis is greatly reduced to have a viewing cone with light leakage greater than approximately 1% over approximately 40°.

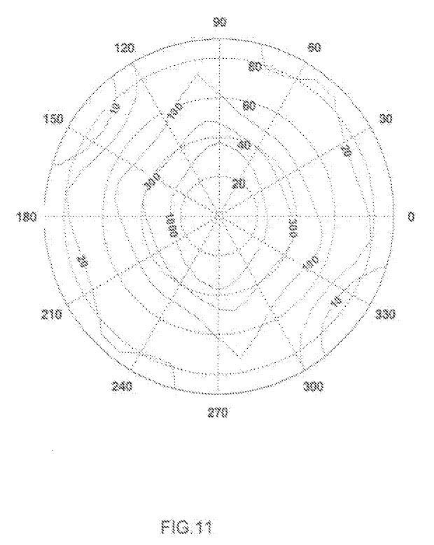

The viewing angle plot is shown in FIG. 11 with

$${ϕ}_{- \frac{1}{2} λ} = approximately + 73 ° , {ϕ}_{+ \frac{1}{4} λ} = approximately - 79 ° , {ϕ}_{- \frac{1}{4} λ} = approximately - 75 ° , {ϕ}_{+ \frac{1}{2} λ} = approximately + {75}^{°}$$

and dΔn of the C film is set at approximately −270 nm, where contrast ratio >10:1 is over 80° at most directions. Similarly, the half-wave plate can also have an angle close to

$${ϕ}_{\frac{1}{2} λ} = approximately - 75 °$$

and the quarter-wave plate could be

$${ϕ}_{{1}_{4} λ} = approximately 75 ° to satisfy 2 {ϕ}_{\frac{1}{4} λ} - 4 {ϕ}_{{1}_{2} λ} = + \frac{π}{2} + 2 m π .$$

### Embodiment 3

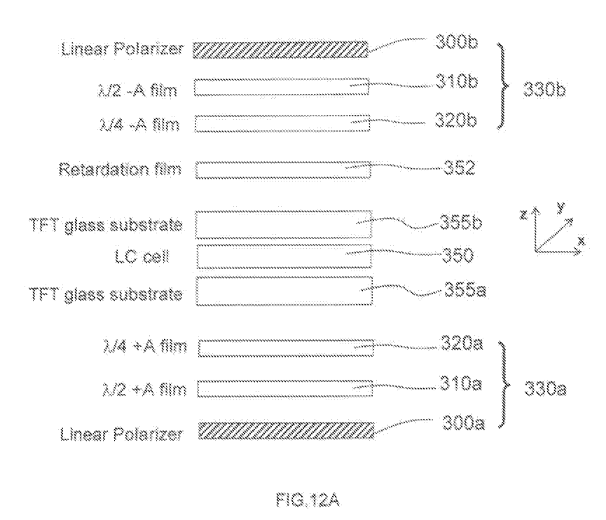

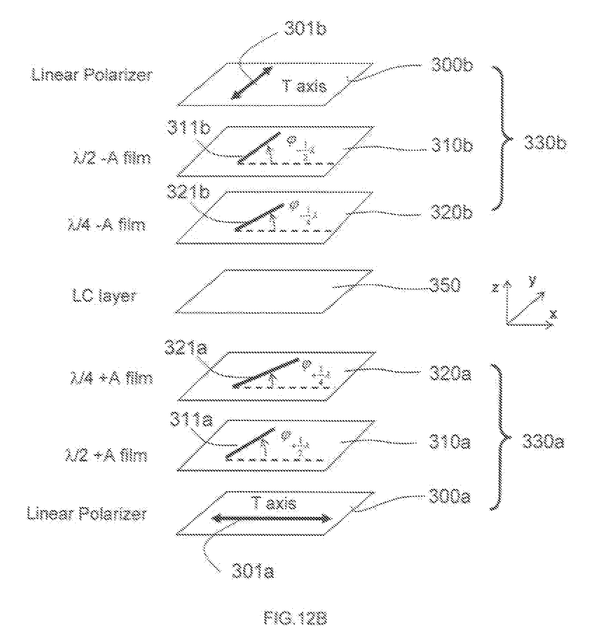

Yet in anther embodiment of the wide-view and broadband circular polarizer structure for a transflective typed LCD in FIG. 12A, the half-wave plate and the quarter-wave plate within each circular polarizer are of the same type (e.g., both are positive A plates, or both are negative plates), but corresponding half-wave plate or quarter-wave plate in different circular polarizers are of the opposite type. In FIG. 12A, a first linear polarizer 300a along with a first half-wave plate 310a and a first quarter-wave plate 320a forms the first broadband and wide-viewing angle circular polarizer 330a. Here both half-wave and quarter-wave plates in the first circular polarizer are made of positive A plates, wherein the transmission axis 301a of the linear polarizer 300a is set along the x-axis and the optic axes of the wave plates 310a and 320a are set at

$${ϕ}_{+ \frac{1}{2} λ} and {ϕ}_{+ \frac{1}{4} λ} .$$

On the other side a second linear polarizer 300b along with a second half-wave plate 310b and a second quarter-wave plate 320b forms the second broadband and wide-viewing angle circular polarizer 330b. And both half-wave and quarter-wave plates are made of negative A plates, wherein the transmission axis 301b of the linear polarizer 300b is set perpendicular to that of the first linear polarizer 300a and the optic axes of the wave plates 310b and 320b are set at

$${ϕ}_{- \frac{1}{2} λ} and {ϕ}_{- \frac{1}{4} λ} .$$

A liquid crystal 350 interposed between two TFT glass substrates 355a and 355b is sandwiched between the circular polarizers to switch between the dark state and bright state. Corresponding optic axis alignment is illustrated in FIG. 12B.

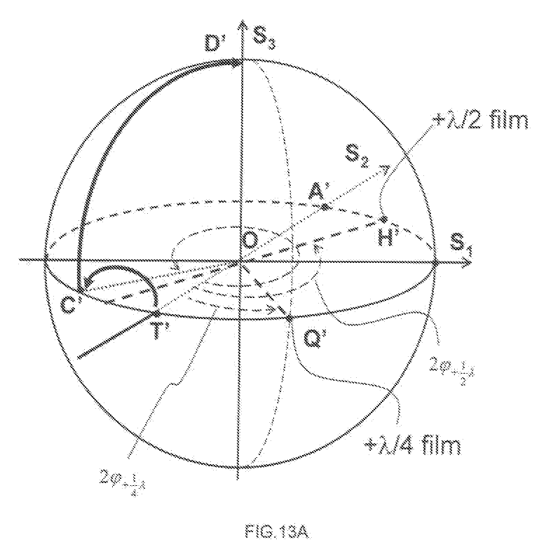

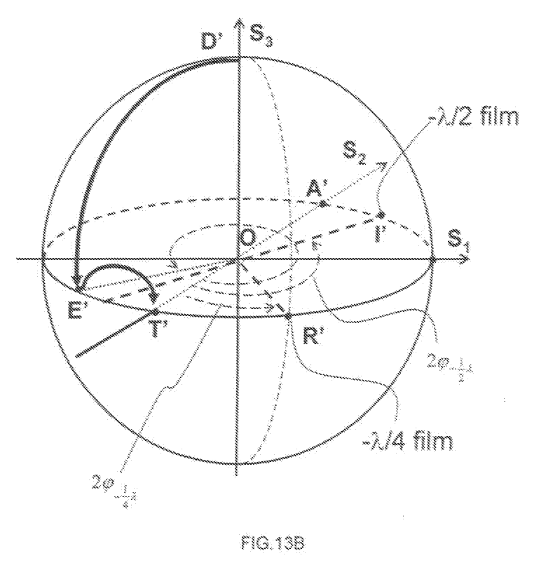

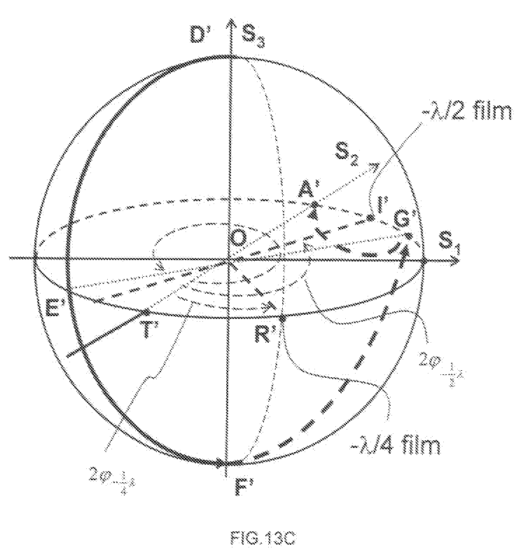

FIG. 13A shows the required optic axis alignment for same type films within each circular polarizer through the Poincaré sphere. Similarly, the angle φ_{1/2λ} of the top half-wave plate is set at approximately 75° with respect to the transmission axis of the bottom circular polarizer, which is also −15° away from the top polarizer's transmission direction 301b. Then the angle of the bottom half-wave plate is also set at that value. Therefore, for example, the transmission axis of the bottom polarizer 300a can be represented by the point T′ on the Poincaré sphere and the optic axis of the half-wave plate 310a can be characterized by the point H′, which as an angle of

$$2 {ϕ}_{+ \frac{1}{2} λ}$$

to the OT′ axis

$$( ∠ H ’ OT ’ = 2 {ϕ}_{+ {1}_{2} λ} = approximately 150 ° \text{)} ,$$

and the optic axis of the quarter-wave plate 320a is represented by the point Q′ that has an angle

$$∠ Q ’ OT ’ = 2 {ϕ}_{+ \frac{1}{4} λ}$$

to the OT′ axis.

The light passing the polarizer 300a will have a polarization state of T′, then the half-wave plate will move it to the point C′, which is also a linear polarization with an angle

$$∠ C ’ OT ’ = 4 {ϕ}_{+ \frac{1}{2} λ} = approximately 300 °$$

or approximately −60°. Then the quarter-wave plate 320a will rotate the linear polarization C′ to the pole D′.

Here in order to make the traces all above or below the same half-sphere, it requires

$$2 {ϕ}_{+ \frac{1}{4} λ} - 4 {ϕ}_{+ \frac{1}{2} λ} = + \frac{π}{2} + m π ,$$

where m can be equal to 0, ±1. Similarly for the top circular polarizer, it requires

$$2 {ϕ}_{- \frac{1}{4} λ} - 4 {ϕ}_{- \frac{1}{2} λ} = + \frac{π}{2} + m π$$

to achieve broadband property. Therefore, we can determine the angle values as follows:

$${ϕ}_{+ \frac{1}{2} λ} = approximately 75 ° and {ϕ}_{+ \frac{1}{4} λ} = approximately 15 ° , \\ and {ϕ}_{- \frac{1}{2} λ} = approximatel 75 ° and {ϕ}_{- \frac{1}{4} λ} = approximately 15 ° , \\ and m = + 1.$$

FIG. 13B illustrates the mechanism of the dark state when the liquid crystal layer 350 contributes no phase retardation in the normal incidence. The light passing through the bottom circular polarizer 330a will have a circular polarization at D′ on the Poincaré sphere. Then it will be rotated back to the point E′ as a linear polarization by the quarter-wave plate 320b made of a negative A plate, and be further moved to the point T′ by the negative half-wave A plate. Consequently, it will be blocked by the top polarizer 300b, where its transmission axis 301b is perpendicular to the transmission axis 301a of the bottom linear polarizer 300a.

If the liquid crystal is turned to be equivalent to a half-wave plate for the transmissive portion, the cell will appear bright as indicated by FIG. 13C. The light passing the bottom circular polarizer 330a will have circular polarization state at D′ first, then it will be changed in handiness by the liquid crystal layer to the point F′. After passing the quarter-wave plate 320b, the polarization will be further moved to point G′ and be further moved to A′ by the half-wave plate 310b, where A′ is the point representing the transmission axis 301b of the top linear polarizer 300b on the Poincaré sphere. Therefore a bright state can be achieved.

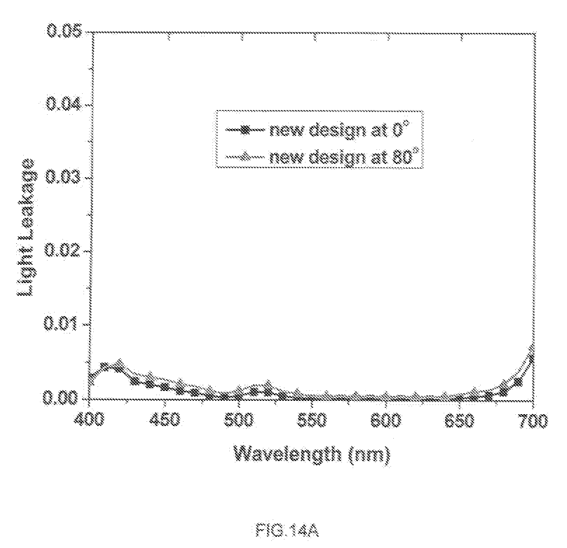

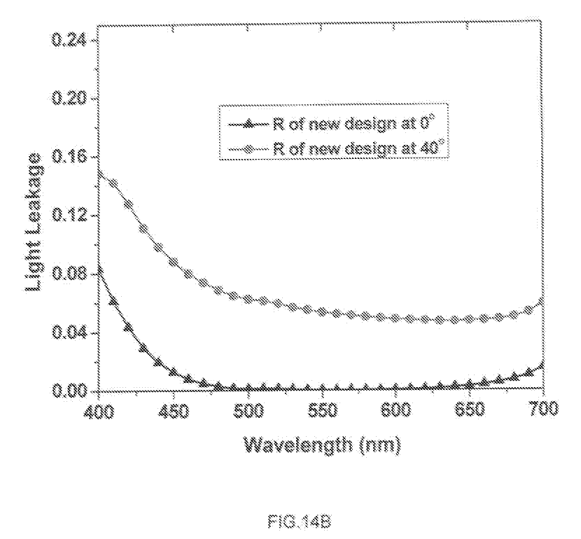

FIG. 14A shows the wavelength dependent light leakage of the present embodiment, where

$${ϕ}_{+ \frac{1}{2} λ} = approximately 75 ° and {ϕ}_{+ \frac{1}{4} λ} = approximately 15 ° , \\ and {ϕ}_{- \frac{1}{2} λ} = approximately 75 ° and {ϕ}_{- \frac{1}{4} λ} = approximately 15 ° .$$

As we can see over the visible range, the light leakage of the T part is less than 0.5% in the normal direction.

FIG. 14B shows the corresponding light leakage with circular polarizer 330b in the reflective configuration. Broadband property still keeps. In addition, their optic angles can also be set at different values such as

$${ϕ}_{+ \frac{1}{2} λ} = approximately 78 ° and {ϕ}_{+ \frac{1}{4} λ} = approximately 21 ° , \\ and {ϕ}_{- \frac{1}{4} λ} = approximately 13 ° and {ϕ}_{- \frac{1}{2} λ} = approximately 74 ° .$$

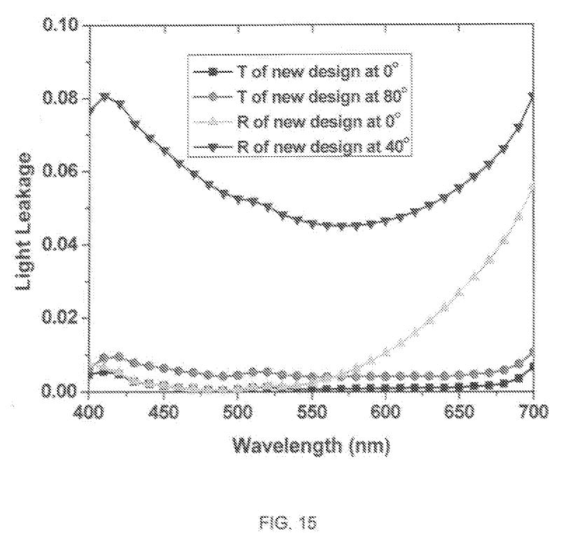

Still the light leakage at all visible lights are all less than 1% for the T mode and less than 8% for the R mode between approximately 450 nm and approximately 700 nm as shown in FIG. 15. And the reflectance at the dark state also remains a broadband property.

The off-axis light leakage with

$${ϕ}_{+ \frac{1}{2} λ} = approximately 75 ° and {ϕ}_{+ \frac{1}{4} λ} = approximately 15 ° , \\ and {ϕ}_{- \frac{1}{2} λ} = approximately 75 ° and {ϕ}_{- \frac{1}{4} λ} = approximately 15 °$$

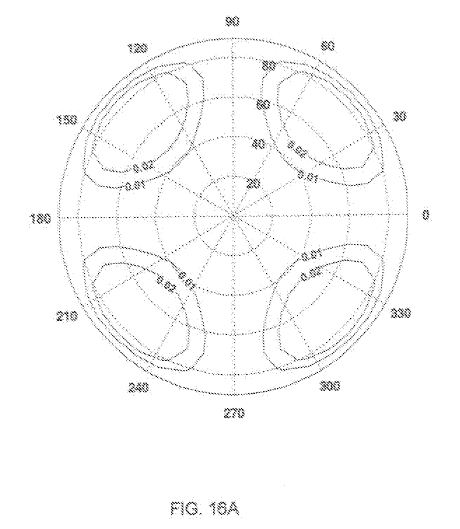

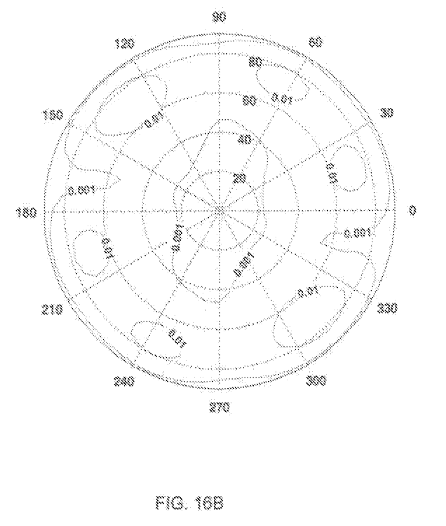

is illustrated in FIG. 16A, where the light leakage is well suppressed to have light leakage less than 1% in a cone with a polar angle over approximately 40° at all azimuthal directions. In other words, under such a configuration, the two circular polarizers are truly broadband and wide-viewing angle, as the off-axis light leakage is well reduced.

Similarly, considering a liquid crystal layer having its molecules substantially perpendicular to the substrate at its dark state, one additional negative C film with retardation value dΔn=approximately −362.5 nm can be applied to compensate the phase retardation from the LC cell itself and the off-axis light leakage from the two linear polarizers.

FIG. 16B shows the light leakage of the embodiment with a negative C plate included and with

$${ϕ}_{+ \frac{1}{2} λ} = approximately 78 ° and {ϕ}_{+ \frac{1}{4} λ} =. approximately 21 ° , \\ and {ϕ}_{- \frac{1}{4} λ} =. approximately 13 ° and {ϕ}_{- \frac{1}{2} λ} =. approximately 74 ° .$$

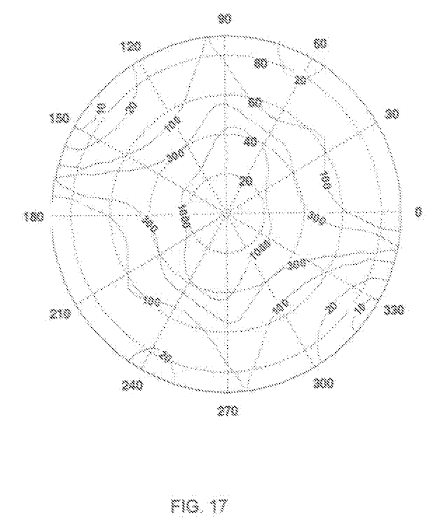

The off-axis light leakage is greatly suppressed than those in FIG. 16A. Besides, as indicated in FIG. 17, the viewing cone with contrast ratio >approximately 10 to 1 is expanded to over. approximately 80° at most directions.

Similarly, the liquid crystal layer is not confined to a normally black LC cell with an initial vertical alignment, it can also use a normally white ECB cell (electrically controlled birefringence) or an OCB cell (optically compensated birefringence) where the LC molecules are substantially vertically aligned at high voltages that are much larger than the threshold voltage of the material.

On the other hand, the azimuthal angle of the top half-wave plate can also be aligned at approximately −75° with respect to the transmission axis 301a of the bottom linear polarizer, which is also approximately +15° to the transmission axis 301b. Therefore a broad bandwidth for the reflective mode can also be guaranteed. In this case, with the assistance of Poincaré sphere, the angles of the half-wave plate and quarter-wave need to satisfy

$$2 {ϕ}_{\frac{1}{4} λ} - 4 {ϕ}_{\frac{1}{2} λ} = - \frac{π}{2} + 2 m π ,$$

where m is an integer that can be 0 or ±1. For example,

$${ϕ}_{+ \frac{1}{2} λ} = approximately - 75 ° , {ϕ}_{+ \frac{1}{4} λ} = approximately - 15 ° , \\ {ϕ}_{- \frac{1}{2} λ} = approximately - 75 ° and {ϕ}_{- \frac{1}{4} λ} = approximately - 15 ° , \\ where m = + 1.$$

### Embodiment 4

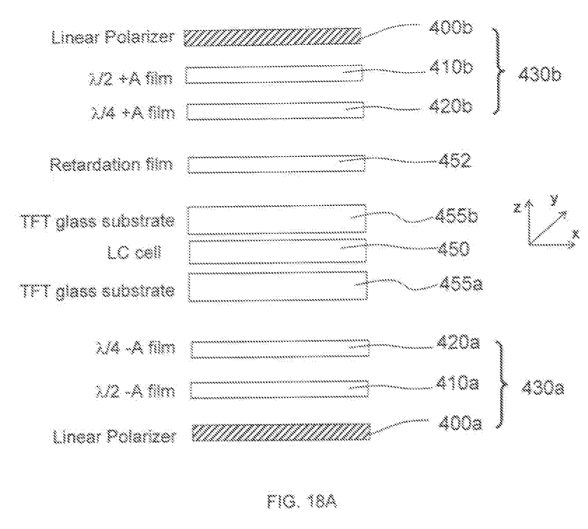

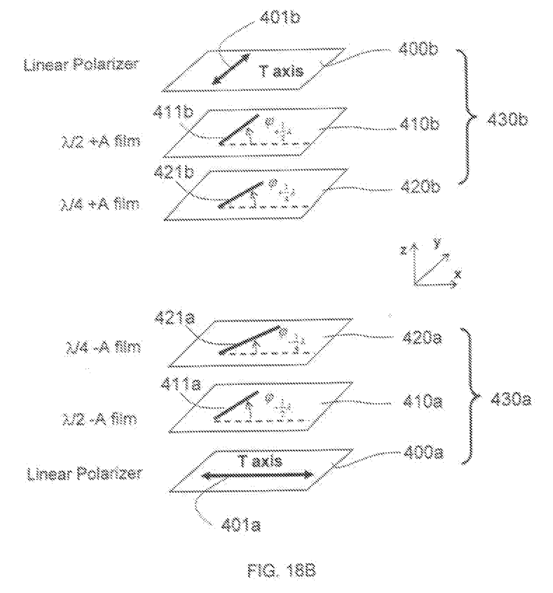

In a fourth embodiment, where the two uniaxial half-wave and quarter-wave plates in top circular polarizer are both made of positive uniaxial A films, and the other two in the bottom circular polarizer are made of negative uniaxial A films. As shown in FIG. 18A, the LC cell 450 is sandwiched between two circular polarizers 430a and 430b. The first circular polarizer 430a further comprises of a first linear polarizer 400a, a first half-wave plate 410a, and a first quarter-wave plate 420a. The second circular polarizer 430b further comprises of a second linear polarizer 400b, a second half-wave plate 410b, and a second quarter-wave plate 420b. Their optic axis is shown in FIG. 18B.

Because the birefringence of each A plate within each circular polarizer is same (e.g., a positive A plate for one wave plate and a positive A plate the other one), when

$${ϕ}_{- \frac{1}{2} λ} = approximately + 75 ° ,$$

the angle between their optic axes should be

$$2 {ϕ}_{\frac{1}{4} λ} - 4 {ϕ}_{\frac{1}{2} λ} = + \frac{π}{2} + 2 m π ,$$

here m is an integer that can be 0 or ±1, and each φ is in the range of (−π/2, π/2].

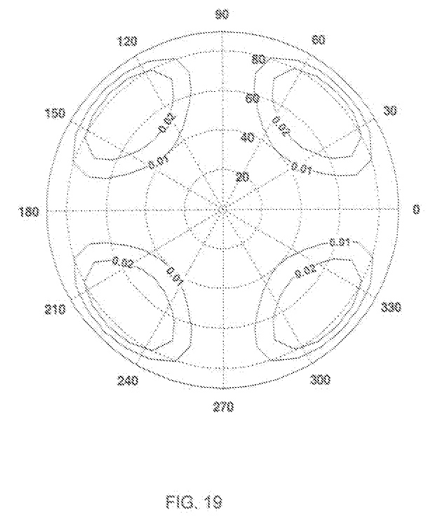

FIG. 19 shows the light leakage where

$${ϕ}_{- \frac{1}{2} λ} = approximately + 75 ° and {ϕ}_{- \frac{1}{4} λ} = approximately + 15 °$$

in the bottom polarizer,

$${ϕ}_{+ \frac{1}{2} λ} = approximately + 75 ° and {ϕ}_{+ \frac{1}{4} λ} = approximately + 15 °$$

in the top circular polarizer. In this case the reflective ambient light will first see both a positive half-wave plate and a positive quarter-wave plate, as different from the example in the third embodiment.

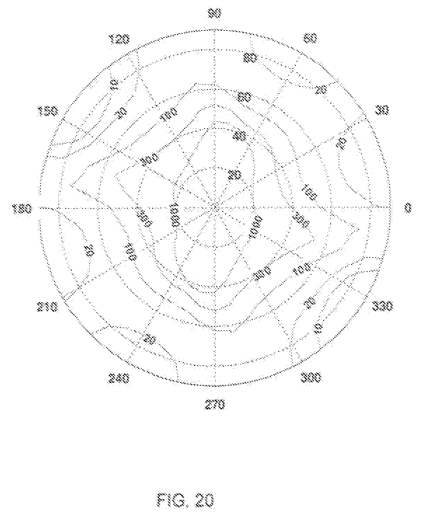

Similarly the light leakage at off-axis is greatly reduced to have a viewing cone with light leakage greater than approximately 1% over approximately 40°. The viewing angle plot including a LC layer is shown in FIG. 20, where contrast ratio >approximately 10 to approximately 1 is over approximately 80° at most directions. Similarly, the half-wave plate can also have an angle close to

$${ϕ}_{\frac{1}{2} λ} = - 75 °$$

and the quarter-wave plate could be

$${ϕ}_{\frac{1}{4} λ} = approximately - 15 ° to satisfy 2 {ϕ}_{\frac{1}{4} λ} - 4 {ϕ}_{\frac{1}{2} λ} = - \frac{π}{2} + 2 m π .$$

In summary, the structures of the present invention attain wide viewing angle and broadband circular polarizers, which are quite promising for wide viewing angle, full color transflective and transmissive LCDs.

White the invention has been described, disclosed, illustrated and shown in various terms of certain embodiments or modifications which it has presumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

We claim:

1. A liquid crystal display device comprising:
a first transparent substrate;
a second transparent substrate;
a liquid crystal cell having a liquid crystal layer sandwiched between the first and the second transparent substrates;
a first circular polarizer disposed behind a viewer's side of the liquid crystal layer; wherein the first polarizer further includes a first linear polarizer, a first half-wave plate, a first quarter-wave plate;
a second circular polarizer disposed on the viewer's side of the liquid crystal layer; wherein the second polarizer includes a second linear polarizer, a second half-wave plate, and a second quarter-wave plate;
at least one optical retardation compensator disposed between the first circular polarizer and the second circular polarizer;
wherein the first half-wave plate and the first quarter-wave plate are positioned between the inner surface of the first linear polarizer and the liquid crystal layer, having the first half-wave plate closer to the first polarizer than the first quarter-wave plate; and the second half-wave plate and the second quarter-wave plate are positioned between the inner surface of the second linear polarizer and the liquid crystal layer, having the second half-wave plate closer to the second polarizer than the second quarter-wave plate;
wherein the first half-wave plate and the second half-wave plate are made of uniaxial A plates with opposite optical birefringence; and the first quarter-wave plate and the second quarter-wave plate are made of uniaxial A plates with opposite optical birefringence; and
a switching means applied to the liquid crystal layer for switching the phase retardation of the liquid crystal layer between a zero and a half-wave plate value for attaining different gray levels.

2. The display of claim 1 wherein the first linear polarizer and the second linear polarizer include dichroic polymer films that have transmission axis perpendicular to each other.

3. The display of claim 2, wherein the dichroic polymer films include:
a polyvinyl-alcohol-based film.

4. The display of claim 1, wherein the first half-wave plate in the first circular polarizer that is away from the viewer includes a positive uniaxial A plate, the first quarter-wave plate includes a negative uniaxial A plate, the second half-wave plate includes a negative uniaxial A plate, and the second quarter-wave plate includes a positive uniaxial A plate.

5. The display of claim 4, wherein the positive and negative uniaxial A plates include:
at least one of a polymer layer or a homogenous liquid crystal film.

6. The display of claim 1 wherein the first half-wave plate in the first circular polarizer that is away from the viewer includes a negative uniaxial A plate, the first quarter-wave plate includes a positive uniaxial A plate; the second half-wave plate includes a positive uniaxial A plate and the second quarter-wave plate includes of negative uniaxial A plate.

7. The display of claim 6, wherein the positive and negative uniaxial A plates include:
at least one of a polymer layer or a homogenous liquid crystal film.

8. The display of claim 4, wherein the optic axis of the second half-wave plate is set at an angle from −30° to −5° with respect to the transmission axis of the second linear polarizer, that is closer to the viewer; the second quarter-wave plate has its optic axis set at from approximately −15° to approximately +35° with respect to the transmission axis of the second linear polarizer, correspondingly; the first half-wave plate has its optic axis angle set at an angle from approximately −30° to approximately −5° with respect to the transmission axis of the second linear polarizer; and the first quarter-wave plate has its optic axis angle at an angle from approximately −15° to approximately +35° with respect to the transmission axis of the second linear polarizer, with respect to the transmission axis of the second linear polarizer.

9. The display of claim 6, wherein the optic axis of the second half-wave plate is set at an angle from approximately −30° to approximately −5° with respect to the transmission axis of the second linear polarizer, that is closer to the viewer; the second quarter-wave plate has its optic axis set at from approximately −15° to approximately +35° with respect to the transmission axis of the second linear polarizer, correspondingly; the first half-wave plate has its optic axis angle set at an angle from approximately −30° to approximately −5° with respect to the transmission axis of the second linear polarizer; and the first quarter-wave plate has its optic axis angle at an angle from approximately −15° to approximately +35° with respect to the transmission axis of the second linear polarizer, with respect to the transmission axis of the second linear polarizer.

10. The display of claim 4, wherein the optic axis of the half-wave plate is set at an angle from approximately +5° to approximately +30° with respect to the transmission axis of the second linear polarizer that is closer to the viewer, the second quarter-wave plate has its optic axis set at from approximately −35° to approximately +15° with respect to the transmission axis of the second linear polarizer, correspondingly, the first half-wave plate has its optic axis angle at an angle from approximately −+5° to approximately +30° with respect to the transmission axis of the second linear polarizer, and the first quarter-wave plate has its optic axis angle set at an angle from approximately −35° to approximately +15° with respect to the transmission axis of the second linear polarizer, with respect to the transmission axis of the second linear polarizer.

11. The display of claim 6, wherein the optic axis of the half-wave plate is set at an angle from approximately +5° to approximately +30° with respect to the transmission axis of the second linear polarizer that is closer to the viewer, the second quarter-wave plate has its optic axis set at from approximately −35° to approximately +15° with respect to the transmission axis of the second linear polarizer, correspondingly, the first half-wave plate has its optic axis angle at an angle from approximately +5° to approximately +30° with respect to the transmission axis of the second linear polarizer, and the first quarter-wave plate has its optic axis angle set at an angle from approximately −35° to approximately +15° with respect to the transmission axis of the second linear polarizer, with respect to the transmission axis of the second linear polarizer.

12. The display of claim 1, wherein the first half-wave plate includes a positive uniaxial A plate, the first quarter-wave plate includes a positive uniaxial A plate, the second half-wave plate includes a negative uniaxial A plate, and the second quarter-wave plate includes a negative uniaxial A plate.

13. The display of claim 12, wherein the positive and negative uniaxial A plates include:
at least one of a polymer layer or a homogenous liquid crystal film.

14. The display of claim 1 wherein the first half-wave plate includes a negative uniaxial A plate, the first quarter-wave plate includes a negative uniaxial A plate; the second half-wave plate includes a positive uniaxial A plate and the second quarter-wave plate includes a positive uniaxial A plate.

15. The display of claim 14, wherein the positive and negative uniaxial A plates include:
at least one of a polymer layer or a homogenous liquid crystal film.

16. The display of claim 12, wherein the optic axis of the second half-wave plate is set at an angle from approximately −30° to approximately −5° with respect to the transmission axis of the second linear polarizer that is closer to the viewer, the second quarter-wave plate has its optic axis set at from approximately −15° to approximately +35° with respect to the transmission axis of the first linear polarizer that is away from the viewer correspondingly, the first half-wave plate has its optic axis angle set at an angle from approximately −30° to approximately −5° with respect to the transmission axis of the second linear polarizer, and the first quarter-wave plate has its optic axis angle at an angle from approximately −15° to approximately +35° with respect to the transmission axis of the first linear polarizer, with respect to the transmission axis of the second linear polarizer.

17. The display of claim 14, wherein the optic axis of the second half-wave plate is set at an angle from approximately −30° to approximately −5° with respect to the transmission axis of the second linear polarizer that is closer to the viewer, the second quarter-wave plate has its optic axis set at from approximately −15° to approximately +35° with respect to the transmission axis of the first linear polarizer that is away from the viewer correspondingly, the first half-wave plate has its optic axis angle set at an angle from approximately −30° to approximately −5° with respect to the transmission axis of the second linear polarizer, and the first quarter-wave plate has its optic axis angle at an angle from approximately −15° to approximately +35° with respect to the transmission axis of the first linear polarizer, with respect to the transmission axis of the second linear polarizer.

18. The display of claim 12, wherein the optic axis of the second half-wave plate is set at an angle from approximately +5° to approximately +30° with respect to the transmission axis of the second linear polarizer that is closer to the viewer, the second quarter-wave plate has its optic axis set at from approximately −35° to approximately +15° with respect to the transmission axis of the first linear polarizer that is away from the viewer correspondingly, the first half-wave plate has its optic axis angle set at an angle from approximately +5° to approximately +30° with respect to the transmission axis of the second linear polarizer, and the first quarter-wave plate has its optic axis angle set at an angle from approximately −35° to approximately +15° with respect to the transmission axis of the first linear polarizer, with respect to the transmission axis of the second linear polarizer.

19. The display of claim 14, wherein the optic axis of the second half-wave plate is set at an angle from approximately +5° to approximately +30° with respect to the transmission axis of the second linear polarizer that is closer to the viewer, the second quarter-wave plate has its optic axis set at from approximately −35° to approximately +15° with respect to the transmission axis of the first linear polarizer that is away from the viewer correspondingly, the first half-wave plate has its optic axis angle set at an angle from approximately +5° to approximately +30° with respect to the transmission axis of the second linear polarizer, and the first quarter-wave plate has its optic axis angle set at an angle from approximately −35° to approximately +15° with respect to the transmission axis of the first linear polarizer, with respect to the transmission axis of the second linear polarizer.

20. The display of claim 1, wherein the at least one optical retardation compensator is laminated between the liquid crystal layer and one of the first and second circular polarizers.

21. The display of claim 20, wherein the optical retardation compensator includes: a negative C film.

22. The display of claim 20, wherein the optical retardation compensator includes: a negative C film having a total phase retardation value (dΔn) between approximately −400 nm to approximately −250 nm.

23. The display of claim 1 wherein the liquid crystal cell is a transmissive liquid crystal cell.

24. The display of claims 23, wherein the liquid crystal layer is selected from a group consisting of: a vertically aligned cell, electrically controlled birefringence cell, and an optically compensated birefringence cell.

25. The display of claim 1 wherein the liquid crystal cell is a transflective liquid crystal display.

26. The display of claim 25, wherein the transflective display includes:
a first transparent substrate;
a second transparent substrate;
a liquid crystal cell;
a first circular polarizer, wherein the first polarizer further includes a first linear polarizer, a first half-wave plate, a first quarter-wave plate;
a second circular polarizer, wherein the second polarizer includes a second linear polarizer, a second half-wave plate, and a second quarter-wave plate; and the second circular polarizer located closer to the front side of the display than the first circular polarizer; and
pixel circuits between the first and second substrates, each of the pixel circuits having a transmissive portion and a reflective portion, wherein the reflective portion includes a reflector for reflecting the external light, and the transmissive portion includes a transmitter to modulate light generated by an internal light source.

27. The display of claim 25, wherein the transflective display includes:
a first transparent substrate;
a second transparent substrate;
a first circular polarizer, wherein the first polarizer further comprises of a first linear polarizer, a first half-wave plate, a first quarter-wave plate;
a second circular polarizer, wherein the second polarizer comprises of a second linear polarizer, a second half-wave plate, and a second quarter-wave plate; and the second circular polarizer located closer to the front side of the display than the first circular polarizer;
a liquid crystal layer, in which a portion of the liquid crystal layer is used to modulate light when the display is operating in a transmissive mode, and the same portion of the liquid crystal layer is used to modulate light when the display is operating in a reflective mode, and

28. The display of claim 26, wherein the first half-wave plate and the first quarter-wave plate are positioned between the inner surface of the first linear polarizer and the liquid crystal layer having the first half-wave plate closer to the first linear polarizer, and the second half-wave plate and the second quarter-wave plate are positioned between the inner surface of the second linear polarizer and the liquid crystal layer having the second half-wave plate closer to the second linear polarizer, and the first half-wave plate and the second half-wave plate are made of uniaxial A plates and are configured with opposite optical birefringence, and the first quarter-wave plate and the second quarter-wave plate are made of uniaxial A plates and are configured with opposite optical birefringence.

29. The display of claim 27, wherein the first half-wave plate and the first quarter-wave plate are positioned between the inner surface of the first linear polarizer and the liquid crystal layer having the first half-wave plate closer to the first linear polarizer, and the second half-wave plate and the second quarter-wave plate are positioned between the inner surface of the second linear polarizer and the liquid crystal layer having the second half-wave plate closer to the second linear polarizer, and the first half-wave plate and the second half-wave plate are made of uniaxial A plates and are configured with opposite optical birefringence, and the first quarter-wave plate and the second quarter-wave plate are made of uniaxial A plates and are configured with opposite optical birefringence.

30. A liquid crystal display device comprising:
a first broadband circular polarizer;
a second broadband circular polarizer, the first broadband circular polarizer being stacked on the second broadband circular polarizer;
a liquid crystal cell; and
an optical retardation compensator, wherein the liquid crystal cell and the optical retardation compensator are sandwiched between the first and the second broadband circular polarizers.

31. The liquid crystal display device of claim 30, wherein each of the first and the second broadband circular polarizers includes:
a linear polarizer;
a half-wave plate and
a quarter-wave plate, wherein the half-wave plate is between the linear polarizer and the quarter-wave plate, and the two half-wave plates are made of uniaxial A films with opposite optical birefringence and the two quarter-wave plates are made of uniaxial A films with opposite optical birefringence.

32. The liquid crystal display device of claim 30, further comprising:
a switching means applied to the liquid crystal layer for switching the phase retardation compensator between a zero and a half-wave plate value for attaining different gray levels.
